(19) United States
(12) Patent Application Publication
(10) Pub. No.: US 2015/0339266 A1
(43) Pub. Date: Nov. 26, 2015

(54) RANKING METHOD FOR HYBRID RENEWABLE DISTRIBUTED GENERATION SYSTEMS

(71) Applicant: King Fahd University of Petroleum and Minerals, Dhahran (SA)

(72) Inventors: Ssennoga Twaha, Dhahran (SA); Zakariya Mahamoud AI-Hamouz, Dhahran (SA)

(73) Assignee: King Fahd University of Petroleum and Minerals, Dhahran (SA)

(21) Appl. No.: 14/286,353

(22) Filed: May 23, 2014

(51) Int. Cl. G06F 17/18

(52) U.S. Cl. CPC G06F 17/18

(57) ABSTRACT

Discussed herein is a method for determining an efficient hybrid distributed generation (DG) system from a set of hybrid systems. A ranking technique is described which aids in determining the most favored or efficient hybrid renewable DG system. In an initial planning stage, a first stage analysis is performed by using a software tool. Simulation values for the optimal system identifying parameters (OSIP) are obtained from the first stage analysis. Subsequently, a ranking and selection technique is applied on the OSIPs, as a second stage optimization. Upon performing the second stage analysis, an efficient hybrid DG system can be determined. However, if multiple systems are identified in the second stage analysis, further constraints can be imposed to identify a single favored or efficient solution or at least reduce the number of available options from which an energy system may be selected, thereby reducing selection complexity.

### BACKGROUND

1. Field of Disclosure

Embodiments described herein generally relate to a ranking and selection method and a computer-implemented method thereof for determining an efficient hybrid renewable energy system from a plurality of energy systems.

2. Description of the Related Art

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Renewable-based distributed generation (DG) systems are a promising candidate that may provide tremendous economical benefits if operated in effective and efficient manner. With the price of oil reaching its highest levels and the costs of transmission line expansion rapidly increasing, combined with the desire to reduce carbon dioxide emissions, renewable energy has become an important alternative as a power provider in rural systems. The cost of energy from conventional sources is less than that from renewable energy sources, but a supply-mix of renewable energy and diesel can reduce the cost of energy.

The ever increasing need for electric power generation, progress in power deregulation and utility restructuring, have created increased interest in distributed power generation. Renewable energy currently contributes approximately 13% of the total global primary energy supply. Renewable sources such as wind and solar photovoltaic (PV) systems have recently gained tremendous attention as production costs decrease and also due to national government incentives. The reduction of primary energy use and greenhouse gas emissions in the energy sector can be attained by increasing the use of renewable sources and improving energy efficiency. Many national and international research programs have targeted their research work at developing innovative technologies and new energy forms of renewable energy. The concept of integration of distributed energy resources for formation of micro-grids will be most significant in near future. DG systems mostly comprise of renewable sources such as solar, PV, wind, geothermal, hydro and other non-renewable sources such as combined heat and power (CHP) generation systems. The energy resources can be setup as individual stand-alone systems, for example solar PV systems or wind renewable systems. However, due to the disadvantages associated with such a setting, such as variation in solar power output due to changes in solar radiation and the like, hybrid systems are favored.

Hybrid energy systems can include a variety of energy sources such as solar PV/wind, solar PV/hydro/wind, diesel generator/solar PV/wind battery systems or the like. With a variety of hybrid systems available, power system planners and researchers are often faced with the challenging task of determining, before actual implementation, as to which hybrid DG system would perform in an efficient manner.

Several studies have been conducted on the design and analysis of hybrid DG systems through application of different tools. A study conducted by Entchev. E et al “Simulated hybrid renewable micro-generation systems in load sharing applications”, incorporated by reference herein, focusses on the effect of hybrid power systems under different loads. A study of solar PV-diesel-battery hybrid power system for a remotely located population near Raffia, Saudi Arabia was conducted by S. Rehman and L. M. Al-Hadhrami, “Study of a solar PV-diesel-battery hybrid power system for a remotely located population near Raffia, Saudi Arabia”, Energy, vol. 35, no. 12, pp. 4986-4995, December 2010, incorporated by reference herein, considers a stand alone energy system. A feasibility study of small Hydro/PV/Wind hybrid electric supply system to the district was conducted by G. Bekele and G. Tadesse, “Feasibility study of small Hydro/PV/Wind hybrid system for off-grid rural electrification in Ethiopia,” Appl. Energy, vol. 97, pp. 5-15, September 2012, incorporated by reference herein, in which the authors identify six sites with small-scale hydropower potentials.

Further, the performance of a proposed grid-connected hybrid system consisting of a wind generator and PV panels to extract the maximum power from wind and solar energy sources and balanced by a diesel electric generator was conducted by C. M. Hong, T.-C. Ou, and K.-H. Lu, “Development of intelligent MPPT (maximum power point tracking) control for a grid-connected hybrid power generation system,” Energy, vol. 50, pp. 270-279, February 2013, and is incorporated by reference herein. O. Hafez and K. Bhattacharya, conducted a study, “Optimal planning and design of a renewable energy based supply system for microgrids,” Renew. Energy, vol. 45, pp. 7-15, September 2012, incorporated by reference herein, in which planning and design of a renewable energy based supply system is performed. Different systems including a diesel-only, a fully renewable-based, a diesel-renewable mixed, and an external connected grid were designed in order to compare and evaluate the economics, operational performance and environmental emissions of each of the energy systems. The different energy systems were compared based on predetermined system parameters. However, a drawback of the planning and designing of the hybrid systems lacks an indication as to which one of the hybrid systems under consideration results in an efficient and commercially viable solution, when all the system parameters are considered. Furthermore, the system parameters are considered independent of each other and no analysis is performed for a case wherein, there is a mutual dependency of the system parameters.

Accordingly, there is a requirement for a framework that aids in determining an efficient hybrid DG system among a plurality of different renewable energy systems, when all the energy systems parameters and their mutual dependencies on each other are considered.

### SUMMARY

The present disclosure describes a model and a computer-implemented method for determining an efficient hybrid renewable distributed generation (DG) system. A ranking and selection technique is described that determines an efficient hybrid system from a plurality of renewable based energy systems. Ranking and selection procedures are described that select the best hybrid system design from among a set of alternative systems. The ranking and selection procedures also provide error control by ensuring sufficient sampling of the individual candidates such that an efficient and/or effective energy system is chosen with a user specified probability. According to an embodiment, Homer simulation results (to be described) are employed in a first stage process and an ranking technique is employed as a second stage process in order to determine the efficient hybrid DG system.

Accordingly, an embodiment of the present disclosure provides a method of determining an efficient distributed energy system from a plurality of distributed energy systems, the method including: assigning a rank to each parameter of a plurality of parameters based on a simulated value of the parameter and a predetermined criteria, the plurality of parameters governing a performance of each distributed energy system; computing an overall rank for each distributed energy system based on the assigned rank to each parameter of the plurality of parameters; calculating, for each distributed energy system, a cumulative rank for a subset of the plurality of parameters based on the assigned rank of each parameter belonging to the subset of the plurality of parameters; identifying whether a single distributed energy system has a minimum overall rank or multiple energy systems have the minimum overall rank; and selecting, based on the identifying, one of the distributed energy systems to corresponds to the single distributed energy system and the efficient distributed energy system being computed based on the cumulative ranks of the multiple distributed energy systems.

Another embodiment provides a non-transitory computer readable medium having stored thereon a program that when executed by a computer causes the computer to execute a method of determining an efficient distributed energy system from a plurality of distributed energy systems. The method includes: assigning a rank to each parameter of a plurality of parameters based on a simulated value of the parameter and a predetermined criteria, the plurality of parameters governing a performance of each distributed energy system; computing an overall rank for each distributed energy system based on the assigned rank to each parameter of the plurality of parameters; calculating, for each distributed energy system, a cumulative rank for a subset of the plurality of parameters based on the assigned rank of each parameter belonging to the subset of the plurality of parameters; identifying whether a single distributed energy system has a minimum overall rank or multiple energy systems have the minimum overall rank; and selecting, based on the identifying, one of the distributed energy systems to correspond to the single distributed energy system and the efficient distributed energy system being computed based on the cumulative ranks of the multiple distributed energy systems.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

Various embodiments of this disclosure that are proposed as examples will be described in detail with reference to the following figures, wherein like numerals reference like elements, and wherein:

FIG. 1 depicts a flowchart outlining a ranking and selection process according to an embodiment;

FIGS. 2A-2D illustrate four hybrid systems considered in micro-grid planning according to an embodiment;

FIG. 3A illustrates according to an embodiment a cumulative ranking graph for the hybrid systems of FIGS. 2A-2D with the LCOE parameter included in the cumulative ranking computation and FIG. 3B illustrates according to another embodiment a cumulative ranking graph for the hybrid systems of FIGS. 2A-2D without the LCOE parameter being included in the cumulative ranking computation;

FIGS. 4A-4C illustrate according to another embodiment three hybrid systems considered in micro-grid planning;

FIG. 5A illustrates according to an embodiment a cumulative ranking graph for the hybrid systems of FIGS. 4A-4C with the LCOE parameter included in the cumulative ranking computation and FIG. 5B illustrates according to another embodiment a cumulative ranking graph for the hybrid systems of FIGS. 4A-4C without the LCOE parameter being included in the cumulative ranking computation;

FIGS. 6A-6D illustrate four hybrid systems considered in micro-grid planning according to another embodiment and FIG. 6E illustrates a cumulative ranking graph for the hybrid systems of FIGS. 6A-6D; and

FIG. 7 illustrates a block diagram of a computing device according to an embodiment.

### DETAILED DESCRIPTION OF EMBODIMENTS

According to an embodiment of the present disclosure, results from HOMER simulations are analyzed by introducing a ranking technique (e.g., efficiency ranking technique) in order to determine the efficient or favored hybrid DG system. Prior to the application of the ranking technique, optimal system identifying parameters (OSIPs) are identified and their values are either calculated or obtained from HOMER simulation results.

HOMER, a micro-power model, is a software package developed by National Renewable Energy Laboratory (NREL). HOMER assists in the design of both off-grid and grid-connected micro-power systems and it facilitates the comparison of different distributed generation technologies across a variety of applications. Using this software, different potential design options can be compared based on their technical and economic merits. Simulation and sensitivity analysis can be performed by HOMER. In the simulation process, HOMER performs energy balance calculations between demand and supply for each of the 8760 hours in a year. Further, HOMER determines technical feasibility of a configuration and estimates the total cost of installing and operating the system over the lifetime of the project. In an energy system selection, HOMER simulates all possible system configurations and displays a list of configurations satisfying the technical constraints which are sorted by their net present cost (NPC). The net present cost NPC can be computed as follows:

$$NPC = \frac{{C}_{TANN}}{{CRF}_{( i , N )}} \qquad ( 1 )$$

wherein, C_{TANN} is the total annualized cost, i is the annual real interest rate (the discount rate), N is the number of years, and CRF_{(i,N)} is a capital recovery factor. The capital recovery factor can be computed as:

$${CRF}_{( i , N )} = \frac{{i ( 1 + i )}^{N}}{{( 1 + i )}^{N - 1}} \qquad ( 2 )$$

Another system parameter that is dependent on the total annualized cost of the system is Levelized cost of energy (LCOE). The LCOE can be calculated as:

$$LCOE = \frac{{C}_{TANN}}{{E}_{ls} + {E}_{grid}} \qquad ( 3 )$$

where Eₗₛ is the electrical energy that the micro-grid system actually serves and E_{grid} is the amount of electricity sold to the grid by micro-grid. In the levelized cost of energy of (3), the total annualized cost is divided by the electrical load that the micro-grid actually serves. Also, in the levelized cost of energy of (3), the amount of electricity sold to the grid by micro-grid is added.

According to an embodiment, for each hybrid DG system a ranking for each OSIP corresponding to that system is first determined. Further, a sum of the rankings of all OSIPs corresponding to the system is computed. This sum is referred to as the overall rank (OR) of the hybrid DG system. A favored energy distribution of a hybrid DG system is one which has the minimum OR value. The OR for a hybrid system can be represented as:

$${OR}_{i} = {\sum }_{j = 1}^{n} {( OSIP Rank )}_{j} \qquad ( 4 )$$

wherein, the variable n corresponds to the number of OSIPs, the variable i represents an index for the i^{th} hybrid system and the variable j corresponds to an index for the OSIPs. Note that the OSIPs are parameters of the hybrid system that are used to determine the energy distribution and efficiency of the hybrid system. According to one embodiment, the OSIPs include net present cost (NPC), levelized cost of energy (LCOE), total emissions (TE) or emission cost (EC) if the cost of a unit of TE is known, and renewable energy penetration (REP). Note that the inclusion of the above four OSIP parameters in the evaluation of hybrid systems is not to be construed as limiting the scope of the invention. The technique of ranking and selection described herein is applicable to hybrid energy systems with greater or lesser number of OSIPs.

Further, the OSIPs for a particular hybrid system may be dependent on other OSIPs. The effect of having dependent OSIPs within a system is to shift the value of the OR rank of the system and therefore affect the energy system selection process. Specifically, having dependent OSIPs tends to increase the probability of resulting in more than one system with the least overall rank (OR). For instance, the LCOE may be directly dependent on the NPC. If the value of NPC of the system is high, then the cost of the generated unit of energy from that system will be slightly high and vice-versa. However, when a system with high NPC is subsidized by the government in order to supply low cost energy to the society, the LCOE will be low and therefore these OSIPs no longer have a direct relationship. The effect of dependent OSIPs on the OR of the system will be described later.

In what follows, a process for ranking and selection of the energy systems is described followed by an analysis of the performance evaluation of the ranking technique.

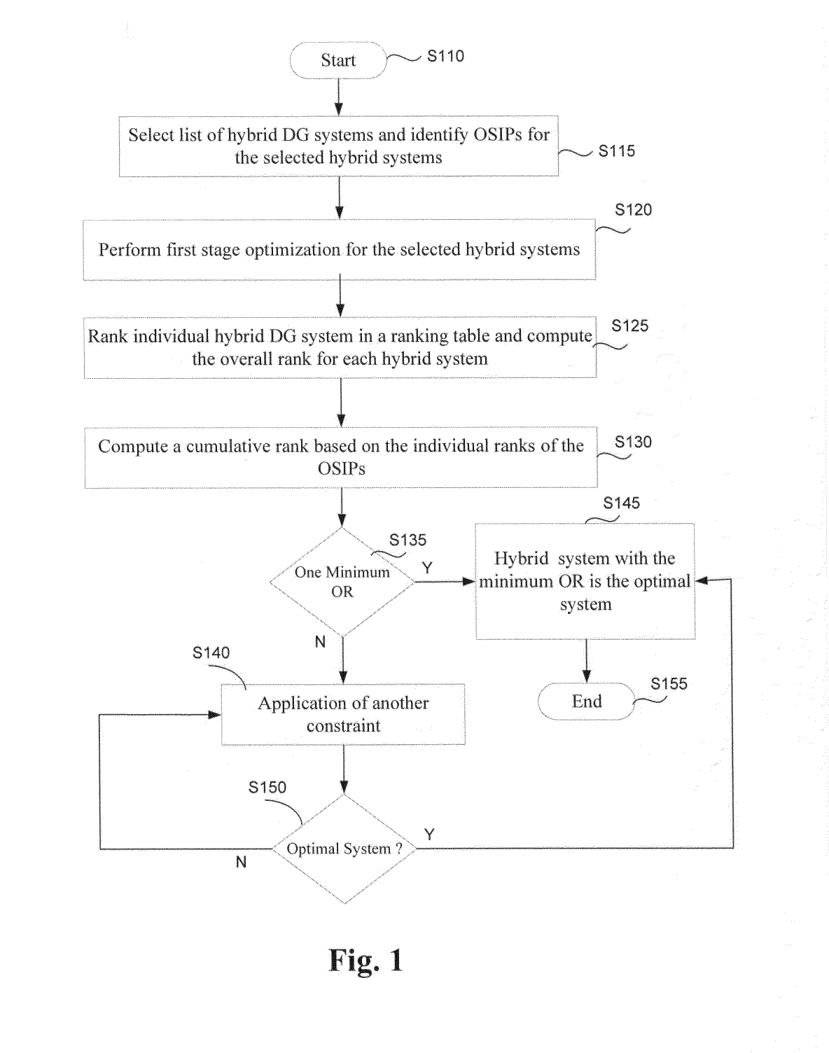

FIG. 1 depicts a flowchart outlining the ranking and selection process according to an embodiment.

The process begins in step S110 and proceeds to step S115. In step S115, the hybrid DG systems to be considered for comparison are selected and input to HOMER software which performs a first stage analysis. According to an embodiment, the selected hybrid systems may be grid-connected wind/hydro/diesel with storage system, grid-connected wind/hydro/PV with storage system, grid-connected wind/hydro/PV without storage system, grid-connected wind/hydro/diesel system, a grid only system and the like. Furthermore, the OSIPs that determine the overall rank of the system are selected during the first stage analysis. Upon selecting the number and type of hybrid systems, along with the OSIPs that are used to evaluate the performance of the system, the process moves to step S120.

In step S120, a first stage analysis of the selected hybrid systems is performed. According to one embodiment, the first stage analysis may be performed on a simulation tool such as HOMER or the like.

In step S125, the results obtained from the first stage analysis are tabulated in a ranking table. Further, ranks are assigned to each OSIP of each hybrid system based on predetermined criteria (to be described). Once ranks are assigned to the individual OSIP parameters, an overall rank of the hybrid system may be computed based on (1). The ranking table may include the selected hybrid DG systems in a first column and the OSIPs along with their ranks in the subsequent columns. The last column bears the overall rank (OR) of each DG system. For instance, according to an embodiment, the ranking table may be one as shown below in Table I. In this case, the ranking table includes systems A, B and C as the selected hybrid DG systems with NPC, TE, and REP selected as OSIPs.

TABLE I
The ranking table

| | OSIP Parameters | | | |
|---|---|---|---|---|
| | NPC Rank | TE Rank | REP Rank | Overall |
| Hybrid DG system | ($/yr) | (ton/yr) | (%) | Rank |

Hybrid DG system A
Hybrid DG system B
Hybrid DG system C

In step S130, a cumulative ranking table is formulated that depicts a cumulative rank of the OSIPs. Note that the cumulative rank is computed based on the individual assigned ranks of the OSIPs. Such a cumulative ranking table may be obtained with the use of a software tool such as Microsoft excel or the like. According to an embodiment, an advantage of formulating the cumulative ranking table may be to compare the DG systems depending on the level of OSIPs considered. For instance, queries such as what would be the favored system if three OSIPs are considered instead of two, and what is the effect of including dependent OSIPs in the ranking model and the like queries can be resolved in an easy manner with the help of the cumulative ranking graph/table.

The process then moves to step S135, wherein a query is made to determine if the computations performed in the previous steps have resulted in a single hybrid system that has the lowest (minimum) overall rank amongst the overall ranks of all hybrid systems. If the response to the query is affirmative the process moves to step S145. If the response to the query is negative, the process moves to step S140.

In step S140, a further constraint is applied to determine which hybrid system (out of the multiple systems having the same overall ranks), should be the most favored hybrid system. For instance if a hydro/PV with storage and wind/hydro/diesel are the systems with same least ORs, then in the areas where we have enough solar radiation and low wind speeds, a hydro/PV with storage may be considered the favored and/or efficient solution. The constraints applied in step S140 may be based on geographical location of the systems, size of the systems and other similar criterion.

The process then proceeds to step S150 wherein, another query is made to check if only a single hybrid system has been determined as a favored system after the application of the constraint in step S140. If the response to the query is negative, the process loops back to step S140 and applies another constraint to the set of hybrid systems in order to select an efficient or favored system.

If the response to the query is affirmative, the process proceeds to step S145, wherein the single hybrid system with the lowest overall rank is determined to be the favored or preferred system, where after the process terminates in step S155.

According to another embodiment, if there are multiple hybrid systems with the same overall rank, even after the application of multiple constraints, the process may be configured to repeat the application of different constraints for a predetermined number of iterations. In such a scenario, the ranking and selection process described above may be configured to output multiple (as opposed to a single) hybrid systems as being favored hybrid systems from the group of hybrid systems considered in step S115.

Upon obtaining the values of the OSIP parameters from the first stage of analysis (step S120) in FIG. 1, the OSIPs are ranked (in step S125) based on predetermined criteria. For instance, according to an embodiment, rankings for the various OSIP parameters are assigned using the ranking Table 1. The parameter net present cost (NPC) is ranked for the various hybrid systems under consideration using the following rule: the system with lowest NPC receives a rank 1 as the particular system is the cheapest cost system assuming that only NPC is considered as OSIP.

The parameter total emission (TE) is ranked for the hybrid systems using the following rule: the system with the lowest TE receives a rank 1, because the objective is to minimize the greenhouse gas (GHG) emissions to reduce the effect of global warming. Similarly, the parameter renewable energy penetration (REP) is ranked as follows: the system with the highest REP receives rank 1, because the objective is to promote the use of renewable energy to support the reduction on the use of fossil fuels which have negative effects on the environment.

It should be noted that there may potentially be scenarios wherein, the results of the first stage analysis are such that two or more system may have the same value for a particular OSIP. For instance, consider hybrid DG systems A, B and C, wherein the results of the first stage analysis have assigned systems A and B each a value of 20% for the REP OSIP and system C has a 60% REP value. In this case, system C will be assigned a rank of 1. However, since systems A and B have the same REP value, a further decision as to how the individual ranks for systems A and B are assigned should be implemented. According to one embodiment, a neutral approach may be implemented, wherein both systems A and B are assigned a rank of 2. Alternatively, according to another embodiment, an unbiased approach may be implemented, wherein the average (2.5) of the two remaining ranks (rank value 2 and rank value 3) may be assigned to both systems. Furthermore, a biased approach may also be used wherein other decision criteria such as size of the system, the cost of the system or the like may be implemented to assign one of the systems a rank of 2 and the other system a rank of 3. An unbiased approach was preferred and used in the analysis in this embodiment.

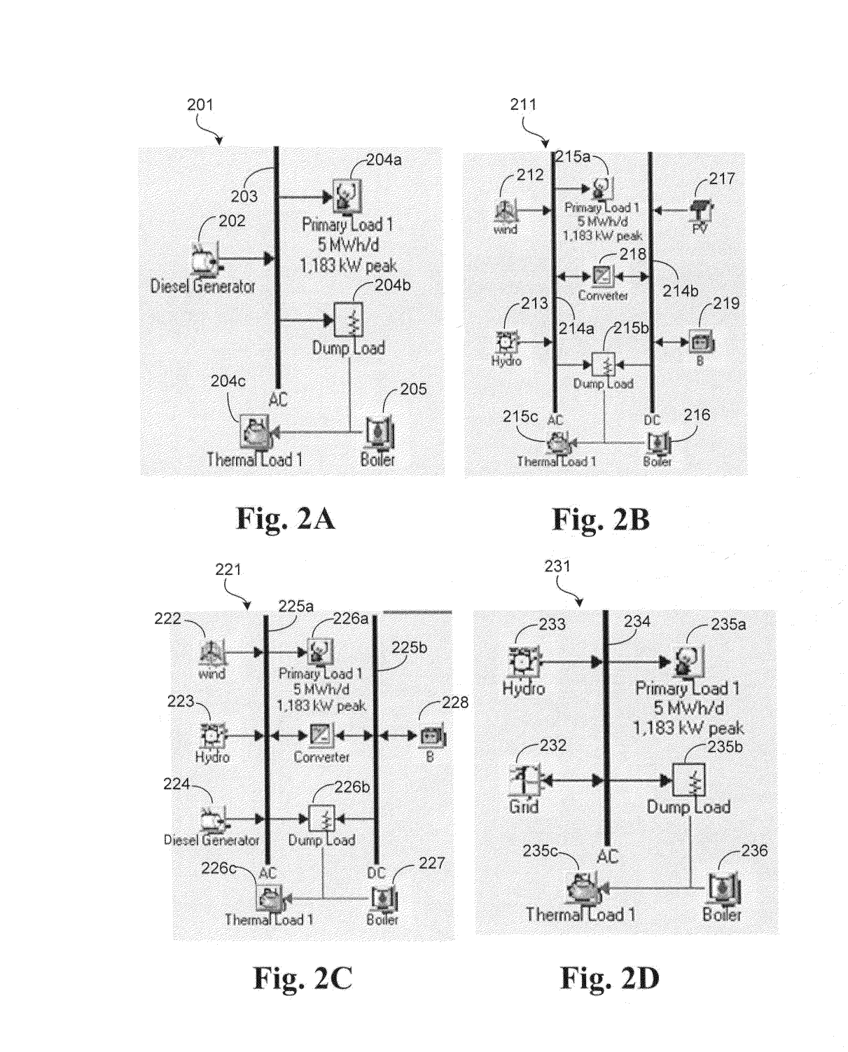

FIGS. 2A-2D illustrate four hybrid systems considered in micro-grid planning according to an embodiment. The first system 201 (referred to herein as case I) depicted in FIG. 2A is a diesel generator-only system. The system 201 includes a diesel generator 202, an AC power supply line 203, a primary load, dump-load and thermal load represented as 204a-204c respectively and a boiler 205. The second system 211 (referred to herein as case II) depicted in FIG. 2B is a wind/solar-PV/hydro with storage hybrid energy system. The system 211 includes a wind power source 212, a Hydro power source 213, a PV power source 217, an AC and DC power supply line represented as 214a and 214b respectively, a primary load, dump-load and thermal load represented as 215a-215c respectively, a boiler 216, a converter 218 configured to convert AC-DC power supply and vice versa, and a power storage system 219.

FIG. 2C depicts the third system 221 (referred to herein as case III) is a diesel/wind/hydro/with storage energy system. The system 221 includes a wind power source 222, a hydro power source 223, a diesel generator 224, an AC and DC power supply line represented as 225a and 225b respectively, a primary load, dump-load and thermal load represented as 225a-225c respectively, a boiler 227 and a power storage system 228. FIG. 2D depicts the fourth energy system 231 (referred to herein as case IV) is a grid connected hydro system. The energy system 231 includes a hydro power source 233 connected to a grid element 232 via an AC power supply line 234. The system also includes a primary load, dump-load and thermal load represented as 235a-235c respectively and a boiler 236.

The four systems are input to a first stage analysis software tool such as HOMER or the like. In this embodiment, the four different cases were considered in order to determine the most favorable option for micro-grid planning. In case I, the micro-grid was assumed to be already installed and is supplied by an isolated network fed by diesel generators. Note that this is the case of many remote power systems around the world that are dependent on imported fossil fuel to feed their demand. Case II considers that the micro-grid is entirely based on renewable energy sources, whereas case III is a mixed configuration comprising both diesel and renewable energy sources. In case IV, it was assumed that the micro-grid has the option of connecting and drawing energy from the external grid.

With an aim of determining the least-cost micro-grid system, while taking into account the environmental impact of each case considered, the micro-grid configuration obtained from the simulation software (HOMER) is shown below in Table II.

TABLE II
Micro-grid plan configuration

| Component | Case 1 | Case 2 | Case 3 | Case 4 |
|---|---|---|---|---|
| Diesel, kW | 6375 | 0 | 4250 | 0 |
| Solar PV, kW | 0 | 500 | 0 | 0 |
| Wind, kW | 0 | 5000 | 1000 | 0 |
| Micro-hydro, kW | 0 | 92 | 92 | 92 |
| External grid, kW | 0 | 0 | 0 | 1200 |

It is observed that while the diesel dependent micro-grid (case I) selects 6375 kW of diesel capacity to meet its demand, the renewable-based micro-grid (case II) completely relies on solar PV, wind, battery storage and micro-hydro generation. The diesel renewable mixed micro-grid (Case III) tends to opt for a reduced diesel generation capacity of 4250 kW and some renewable capacity. Finally, it is observed that when the micro-grid has an option of drawing energy from the external grid (case IV), it relies on that external grid to a large extent.

Table III depicts the component cost and the emissions results for the above described four cases.

TABLE III
Costs components and emission results

| | | | |
|---|---|---|---|
| Case 1 | Case 2 | Case 3 | Case 4 |

Cost components for various cases

| | | | | |
|---|---|---|---|---|
| NPC, M$ | 21.044 | 14.917 | 6.486 | 1.661 |
| LCOE, $/kWh | 0.902 | 0.639 | 0.278 | 0.071 |

Emissions, ton/yr

| | | | | |
|---|---|---|---|---|
| Carbon dioxide | 6004.76 | 3.67 | 1078.4 | 1086.18 |
| Sulfur dioxide | 12.06 | 0.008 | 2.17 | 4.7 |
| Total emissions | 60016.82 | 367.008 | 1080.57 | 1090.88 |

Referring now to Table III, it may be observed that the diesel-renewable mixed micro-grid (case III) is the most economical option when external grid connectivity is not available. However, as many rural systems are fed through local generation, it is possible that some micro-grid may connect to the external grid (case IV) due to its reliability and inexpensiveness. However, if there is a need for the extension of the grid then, the NPC of case IV can be higher than any of the other cases depending on the connectivity distance of the micro-grid.

It can also be observed that the levelized cost of energy (LCOE) is significantly high in case I. Although, in the renewable-based micro-grid (case II) the levelized cost reduces to 0.639 $/kWh, it is still higher than the diesel-renewable mixed micro-grid (case III) because of the significantly large capital cost component in case II. The results depicted in Table III also point out that the renewable micro-grid in case II significantly reduces the total system emissions as compared to all other cases. Further, it may noted that although the emissions in case III are higher than the renewable micro-grid emissions, the system of case III is still quite environmentally friendly when compared to the diesel micro-grid.

Furthermore the results depicted in Table III do not include the REP parameter for the four cases. However, it can be observed that case I has 0% REP, as no electricity is drawn from any renewable energy source. For proper demonstration of the unbiased approach of assigning the ranks, it was assumed that the hydro power resource supplied zero energy and therefore all energy to the load was supplied by the grid. Hence case IV has a 0% REP. The impact of this assumption is to make case I and IV have same rank of 3.5 in REP. Since the renewable-based micro-grid of case II completely relies on solar PV, wind, battery storage and micro-hydro generation, it is likely that it has higher REP compared to Case-3 which opts for a reduced diesel generation capacity of 4250 kW and some renewable capacity. Therefore if case 2 has ‘p’ % REP, then case 3 has ‘p−x’ % REP, where ‘x’ is a constant less that p but greater than zero.

The ranking technique described with reference to FIG. 1 is applied to the energy systems of FIG. 2A-2D. According to an embodiment, ranking is performed for two cases: results are computed with the inclusion of the LCOE parameter and results computed with the exclusion of the LCOE parameter. Note that the inclusion of the LCOE parameter helps to examine the effect of dependent OSIPs. Note that, as stated before the LCOE parameter is dependent on the NPC parameter. The inclusion of NPC together with LCOE may likely cause some negative effect on the value of OR.

Applying the rules of ranking for each OSIP parameter of the hybrid energy system, the ranking tables for the two scenarios of including/excluding the LCOE parameter are shown below in Tables IV-A and IV-B respectively.

TABLE IV-A
Ranking LCOE considered

| | NPC | | LCOE | | TE | | REP | | |
|---|---|---|---|---|---|---|---|---|---|
| Hybrid | Ranking | | Ranking | | Ranking | | ranking | | Overall |
| DG | NPC | | TE | | TE | | REP | | rank |
| system | ($/yr) | Rank | (tons/yr) | Rank | (tons/yr) | Rank | (%) | Rank | (OR) |
| Case 1 | 21.044 | 4 | 0.902 | 4 | 60016.82 | 4 | 0 | 3.5 | 15.5 |
| Case 2 | 14.917 | 3 | 0.639 | 3 | 367.008 | 1 | P | 1 | 8 |
| Case 3 | 6.486 | 2 | 0.278 | 2 | 1080.57 | 2 | P-m | 2 | 8 |
| Case 4 | 1.661 | 1 | 0.071 | 1 | 1090.88 | 3 | 0 | 3.5 | 8.5 |

TABLE IV-B
Ranking without LCOE

| | NPC Ranking | | TE Ranking | | REP ranking | | |
|---|---|---|---|---|---|---|---|
| Hybrid DG | NPC | | TE | | REP | | |
| system | ($/yr) | Rank | (tons/yr) | Rank | (%) | Rank | OR |
| Case 1 | 21.044 | 4 | 60016.82 | 4 | 0 | 3.5 | 11.5 |
| Case 2 | 14.917 | 3 | 3.67.008 | 1 | P | 1 | 5 |
| Case 3 | 6.486 | 2 | 1080.57 | 2 | P-m | 2 | 6 |
| Case 4 | 1.661 | 1 | 1090.88 | 3 | 0 | 3.5 | 7.5 |

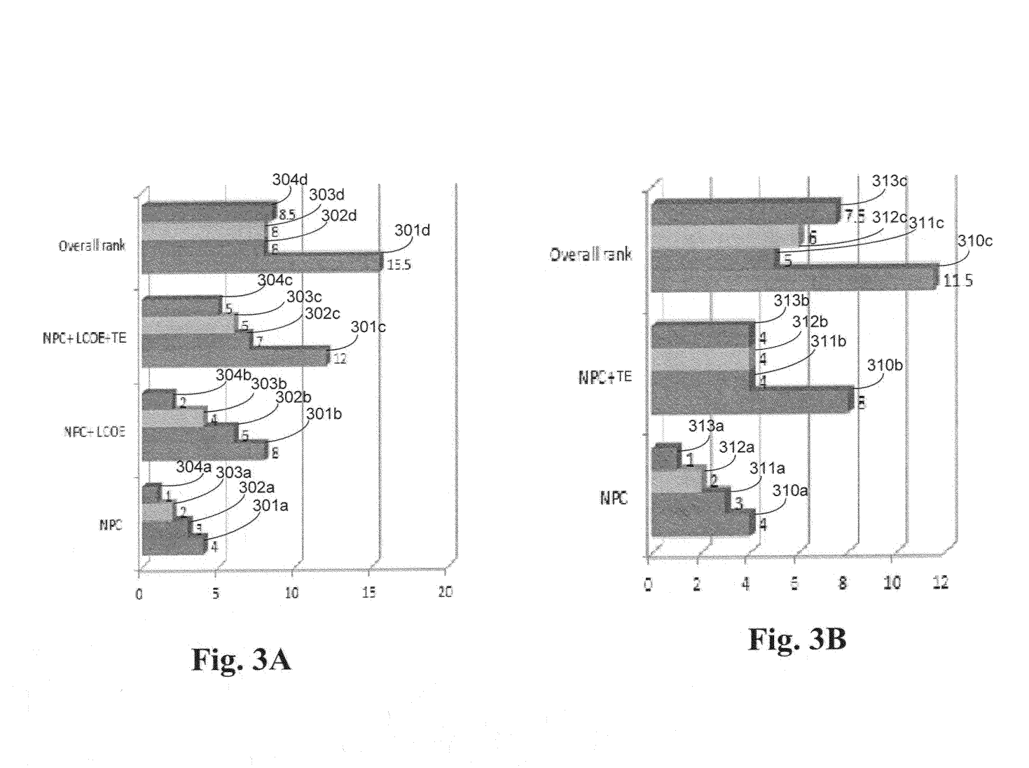

FIGS. 3A and 3B depict a cumulative ranking of the parameters considered in Table IV-A and Table IV-B. Specifically, FIG. 3A shows the cumulative ranking of the parameters NPC, LCOE and TE and FIG. 3B depicts the cumulative rankings with only NPC and TE considered. In both FIGS. 3A and 3B, the Y-axis depicts the parameters considered and also plots the value of the overall rank of the systems (cases I-IV), whereas the X-axis depicts the magnitude of the cumulative ranks.

In FIG. 3A, 301a-301d depict the cumulative ranking and the overall rank of case I (depicted in FIG. 2A), 302a-302d depict the cumulative ranking and the overall rank of case II (depicted in FIG. 2B), 303a-303d depict the cumulative ranking and the overall rank of case III (depicted in FIG. 2C), and 304a-304d depict the cumulative ranking and the overall rank of case IV (depicted in FIG. 2D).

Similarly in FIG. 3B, 310a-310c depict the cumulative ranking and the overall rank of case I (depicted in FIG. 2A), 311a-311c depict the cumulative ranking and the overall rank of case II (depicted in FIG. 2B), 312a-312c depict the cumulative ranking and the overall rank of case III (depicted in FIG. 2C), and 313a-313c depict the cumulative ranking and the overall rank of case IV (depicted in FIG. 2D).

For the sake of convenience, the cumulative rankings depicted in FIGS. 3A and 3B for the cases of including/excluding the LCOE OSIP parameter are also depicted in Table V below:

TABLE V
Cumulative ranking table with and without LCOE parameter.

| | Cumulative ranks | | | | Cumulative ranks | | | |
|---|---|---|---|---|---|---|---|---|
| | with LCOE | | | | without LCOE | | | |
| | Case | Case | Case | Case | Case | Case | Case | Case |
| OSIP | 1 | 2 | 3 | 4 | 1 | 2 | 3 | 4 |
| NPC ($/yr) | 4 | 3 | 2 | 1 | 4 | 3 | 2 | 1 |
| LCOE ($/kWh) | 8 | 6 | 4 | 2 | | | | |
| EP Cost | 12 | 7 | 6 | 5 | 8 | 4 | 4 | 3 |
| (tons/yr) | | | | | | | | |
| REP (%) | 15.5 | 8 | 8 | 8.5 | 11.5 | 5 | 6 | 7.5 |

Referring to the cumulative ranking graph of FIG. 3A, it may be observed that when NPC is the only OSIP considered, case IV (system depicted in FIG. 2D) is the favored case as it is the most inexpensive energy system. In other words, it is cheaper to purchase electricity from the grid instead of installing other DGs. However, if there is no access to the national grid and all systems are only connected to only micro-grids then case III (system depicted in FIG. 2C) is the favored DG system. Further, when NPC and LCOE OSIPs are considered, a similar trend in the result is obtained as compared to the case when only NPC is considered. Specifically, case IV is the favored system. When the TE OSIP is also considered, it can be observed that case IV is still the most favored or efficient followed by case III and then case II. However, it may be observed that case I has a cumulative value that is not as desirable as compared to other cases. This occurs due to high amount of carbon emissions produced from diesel.

According to another embodiment, it may be noted that considering the renewable energy penetration (REP) OSIP to the previous computations tends to completely eliminate case IV from being the favored solution and the favored system is one of case II and case III, which have renewable sources (wind, PV, and hydro) and the same overall rank of 8. In such situations where there are more than one hybrid system having the same overall rank, further constraints need to be applied in order to determine an efficient energy solution. For example, considering the criteria of the maximum amount of solar radiation being available for a specific period in the year, would result in case II being the optimal solution (as compared to case III). Note, that Case IV is eliminated as it was assumed that the hydro renewable source contributes zero energy to the load which results in case IV having a 0% REP.

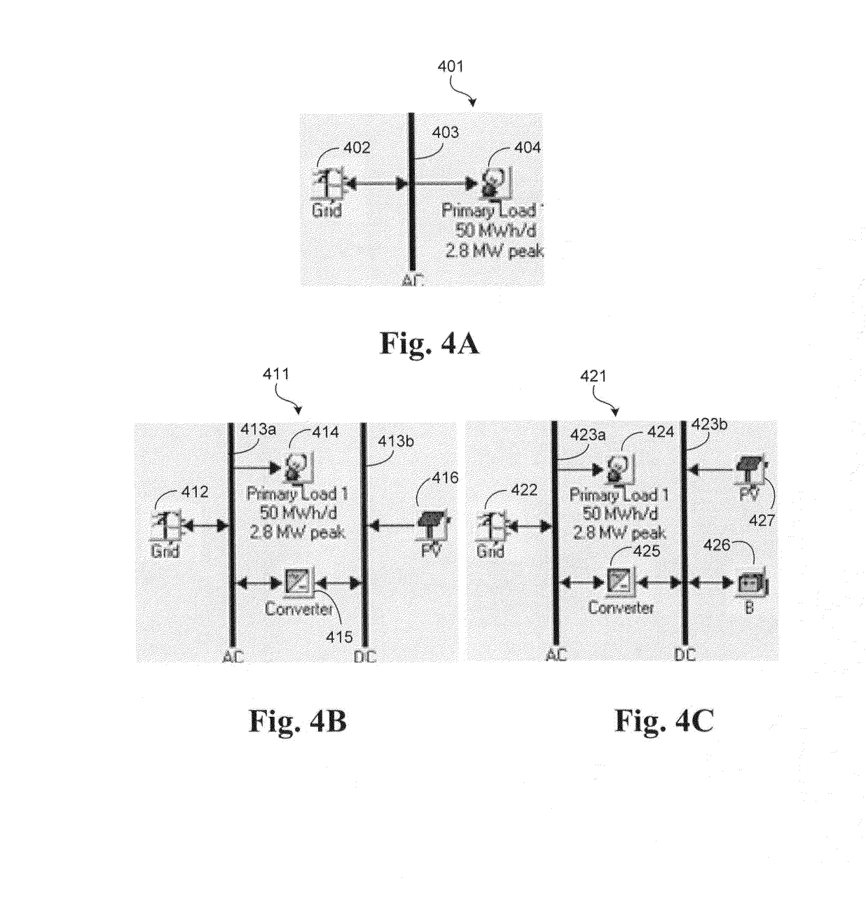

FIGS. 4A-4C illustrate according to another embodiment, three energy systems considered in micro-grid planning. The first system 401 (referred to herein as case I) depicted in FIG. 4A is a grid-only energy supply system. The system 401 includes a grid 402, an AC power supply line 403, and a primary load 404. The second system 411 (referred to herein as case II) depicted in FIG. 4B is grid connected PV system without energy storage. The system 411 includes a grid 412, a PV power source 416, an AC and DC power supply line represented as 413a and 413b respectively, a primary load represented as 414, and a converter 415 configured to convert AC-DC power supply and vice versa.

FIG. 4C depicts the third system 421 (referred to herein as case III) is a grid connected PV system with energy storage. The system 421 includes a grid 422, a PV power source 427, an AC and DC power supply line represented as 423a and 423b respectively, a primary load 424, and a converter 425 configured to convert AC-DC power supply and vice versa.

The three systems are input to a first stage software tool such as HOMER or the like. In this embodiment, the three different cases were considered in order to determine the most favorable option for micro-grid planning. The component cost and emission results obtained from the first stage by using a simulation tool such as HOMER or the like are represented below in Table VI.

TABLE VI
Costs components and emission results of the
systems of FIGS. 4A-4C

| | | |
|---|---|---|
| Case 1 | Case 2 | Case 3 |

Cost components for various cases

| | | | |
|---|---|---|---|
| NPC, $ | 554,706 | 897,692 | 905,543 |
| LCOE, $/kWh | 0.171 | 0.277 | 0.279 |

Emissions, ton/yr

| | | | |
|---|---|---|---|
| Carbon dioxide | 673.23 | 309.22 | 306.7 |
| Sulfur dioxide | 3.4 | 3.1 | 3.02 |
| Total emissions | 676.63 | 312.32 | 309.72 |

Renewable energy penetration (%)

| | | | |
|---|---|---|---|
| REP (%) | 0 | 54 | 54.4 |

Referring to Table VI, it may be observed that the cheapest configuration option may be to use the supply from the grid only without any PV generator (case I) which has an NPC of $554,706. This configuration also has the cheapest cost of energy (LCOE) of $0.171/kWh. Note however, that even though the configuration of case I has the lowest NPC, but the objective of introducing solar PV was to reduce adverse effect of the generated pollutants from the diesel power systems as well as reducing the cost of energy in the future. Thus, under such circumstances it may be concluded that case I is not an acceptable solution, since it is not likely to reduce the dependency on diesel.

Observing the results of case II in Table VI, the grid-connected PV without energy storage system has a total NPC of $897,692, while the cost of energy is $0.277/kWh. Upon comparing the configuration of case II with that of case I, it may be observed that the configuration of case II has higher NPC than that of case I. In other words, even though the consumers have to pay higher for case II ($0.277/kWh) as compared to case I ($0.171/kWh), the configuration of case II supplies a total of 155,707 kWh/year from PV, which is equivalent to a renewable energy penetration rate of 54% out of the total energy supply to the load. In contrast, case I contributes 100% energy from the grid. Thus it has a 0% REP. Thus the system of case II contributes the biggest share of clean/renewable energy which implies that it is likely to reduce the percentage of fuels which are injected to run diesel generators.

The first stage results of case III indicate that system of case III has NPC of $905,543 and a LCOE value of $0.279/kWh. It can be observed that case III (depicted in FIG. 4C) has a slight increase in NPC and LCOE as compared to the system of case II (depicted in FIG. 4B). An energy system setting as depicted in FIG. 4B can be implemented to explore the advantages of using backup energy such as reliability, safety of data in case if computers and other intelligent electronic equipment are connected on the system. Further, note that the renewable energy fraction has slightly increased to 54.4%, as compared to the system of case II, which has a 54% renewable energy fraction. This occurs due to a slight reduction in energy purchased from the grid caused by the use of battery system, which discharges when PV generator output is low. Therefore the configuration of FIG. III tends to further increase the penetration of renewable energy.

Upon applying the ranking technique described herein, the resulting ranking tables for the three cases can be represented as follows:

TABLE VII
Ranking table with LCOE considered for case I-III of FIGS. 4A-4C.

| | NPC | | LCOE | | | | | | |
|---|---|---|---|---|---|---|---|---|---|
| | Ranking | | Ranking | | TE Ranking | | REP ranking | | |
| Hybrid DG | NPC | | LCOE | | TE | | REP | | Overall |
| system | ($/yr) | Rank | ($/kWh) | Rank | (tons/yr) | Rank | (%) | Rank | Rank |
| Case 1 | 554,706 | 1 | 0.171 | 1 | 676.63 | 3 | 0 | 3 | 8 |
| Case 2 | 897,692 | 2 | 0.277 | 2 | 312.32 | 2 | 54 | 2 | 8 |
| Case 3 | 905,543 | 3 | 0.279 | 3 | 309.72 | 1 | 54.4 | 1 | 8 |

In Table VII, the ranking includes the LCOE parameter. The ranking process performed without the LCOE parameter can be represented as follows:

TABLE VIII
Ranking table without LCOE

| Hybrid | NPC Ranking | | TE Ranking | | (REP) ranking | | |
|---|---|---|---|---|---|---|---|
| DG | NPC | | TE | | REP | | Overall |
| system | ($/yr) | Rank | (tons/yr) | Rank | (%) | Rank | Rank |
| Case 1 | 554,706 | 1 | 676.63 | 3 | 0 | 3 | 7 |
| Case 2 | 897,692 | 2 | 312.32 | 2 | 54 | 2 | 6 |
| Case 3 | 905,543 | 3 | 309.72 | 1 | 54.4 | 1 | 5 |

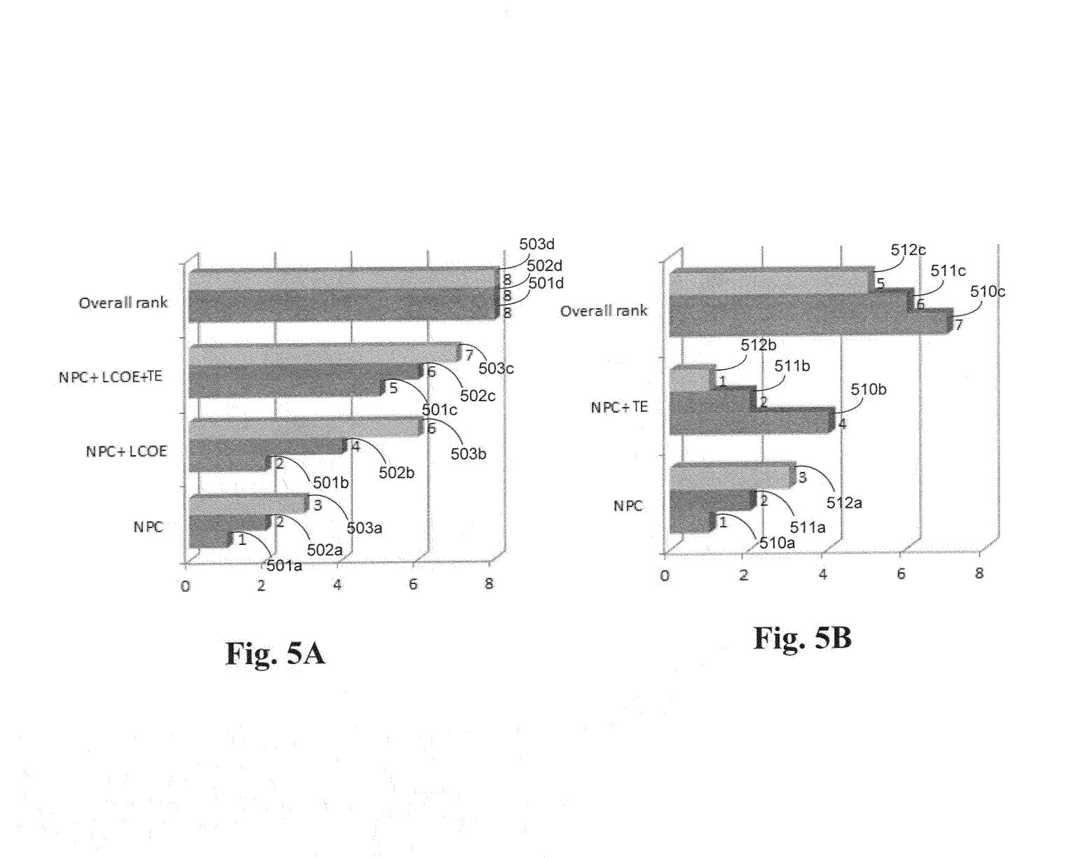

FIGS. 5A and 5B depict a cumulative ranking of the parameters considered in Table VII and Table VIII. Specifically, FIG. 5A shows the cumulative ranking of the parameters NPC, LCOE, TE, and REP. FIG. 5B depicts the cumulative rankings with only NPC, TE, and REP. In both FIGS. 5A and 5B, the Y-axis depicts the parameters considered and also plots the value of the overall rank of the systems (cases I-III of FIGS. 4A-4C), whereas the X-axis depicts the magnitude of the cumulative ranks.

In FIG. 5A, 501a-501d depict the cumulative ranking and the overall rank of case I (depicted in FIG. 4A), 502a-502d depict the cumulative ranking and the overall rank of case II (depicted in FIG. 4B), and 503a-503d depict the cumulative ranking and the overall rank of case III (depicted in FIG. 4C). Similarly in FIG. 5B, 510a-510c depict the cumulative ranking and the overall rank of case I (depicted in FIG. 4A), 511a-511c depict the cumulative ranking and the overall rank of case II (depicted in FIG. 4B), and 512a-512d depict the cumulative ranking and the overall rank of case III (depicted in FIG. 4C).

For the sake of convenience, the cumulative ranking table for scenarios of including and excluding LCOE for the cases depicted in Table VII and Table VIII is shown below:

TABLE IX
Cumulative ranking tables with and without LCOE

| | Cumulative ranks | | | Cumulative ranks | | |
|---|---|---|---|---|---|---|
| | with LCOE | | | without LCOE | | |
| OSIP | Case 1 | Case 2 | Case 3 | Case 1 | Case 2 | Case 3 |
| NPC ($/yr) | 1 | 2 | 3 | 1 | 3 | 2 |
| LCOE ($/kWh) | 2 | 4 | 6 | | | |
| EP Cost | 5 | 6 | 7 | 4 | 4 | 4 |
| (tons/yr) | | | | | | |
| REP (%) | 8 | 8 | 8 | 7 | 5 | 6 |

As observed from FIG. 5A, when only NPC is considered, case I is the favored solution followed by case II and then case III. However, the addition of LCOE as an OSIP creates a slightly bigger margin between the cumulative ranks of case II and case III, each having LCOEs of 4 and 6 respectively. The effect of this can be observed on the OR wherein no single most favored solution is obtained as all the cases have the same OR value of 8.

Considering the case wherein LCOE is not included in the ranking process, and referring to FIG. 5B, it is observed that while considering only the NPC OSIP parameter, case I is the most efficient system due to its lowest incurred cost. However, further consideration of TE parameter and REP parameter results in case III being the most favored solution, as case III has a better TE and REP rank than case II.

Based on the description of the above figures, it may be stated that in the above analysis, when NPC and LCOE OSIPs are considered, the same solution is obtained as when NPC is the only OSIP. This is because the cost of a unit of energy (LCOE, $/kWh) is proportional to the cost of production of energy (NPC, $/yr) and this means that LCOE and NPC are dependent OSIPs. We can see from FIG. 4B that the effect of including LCOE as OSIP when NPC is already included is to increase the rank of case II from 3 to 6 and the rank of case I even further from 4 to 8. Therefore, case III is favored in comparison to case II (when they both have the same OR). The same trend can be observed in FIG. 5A, but this time the effect is even worse because the ORs of all the three cases considered are the same and therefore no one single favored or even near favored or efficient hybrid DG system can be obtained. This is solved by removing LCOE from ranking and the effect is observed in FIGS. 3B and 5B.

From FIG. 5B it can be observed that when we consider only independent OSIPs, it is easier to get the demarcated results of OR and only one effective solution is obtained. Therefore, the advantage is that there will be no need to go for the further analysis to choose the best solution in case we have more than one system with the least OR.

The above described ranking and selection method is not limited to the use of four OSIPS. Rather the framework described herein is applicable to as many OSIPs the power systems planner deems appropriate. For instance, according to another embodiment, a transmission capacity burden (TCB) OSIP may also be included in the ranking and selection process.

TCB is defined as the percentage of the total energy supplied to the load by a transmission line from the grid. One of the driving forces for smart grid is to increase the efficiency of power transmission system in an environmentally friendly way. Therefore, TCB indicates the extent to which the transmission line is used and therefore measures can be taken to reduce its loading since this can lead to adverse voltage variations and losses into the power system. The minimum TCB is 0% which occurs when no electricity is purchased from the grid and the maximum TCB is 100% which occurs when all the energy supplied to the load is from the grid. TCB can be computed as:

$${TCB}_{i} = \frac{{E}_{grid}}{{E}_{D}} * 100 \% \qquad ( 5 )$$

Wherein, E_{D} is the total energy supplied to the load (kWh/yr.) and E_{grid} is the energy supplied to the load from the grid (kWh/yr). Further, it may be assumed that the energy sold to the grid from the DG is sold to the nearby consumers and does not affect the TCB value. Hence the electricity sold to the grid is not considered in calculating TCB.

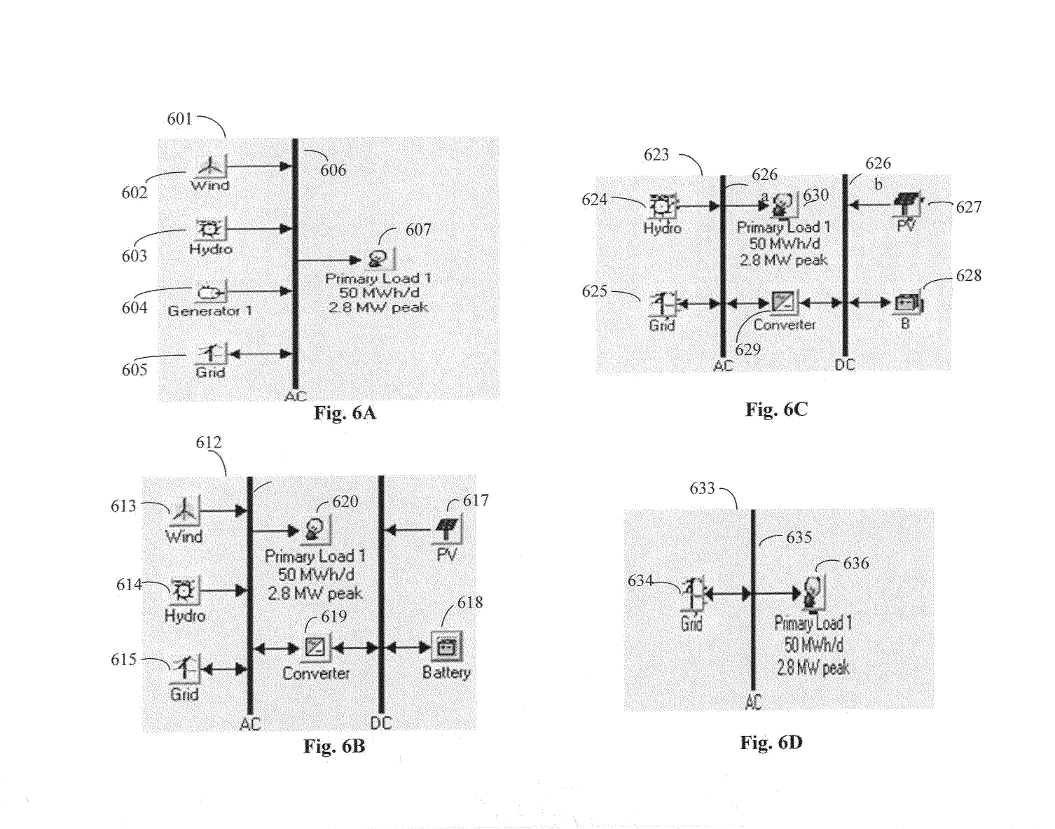

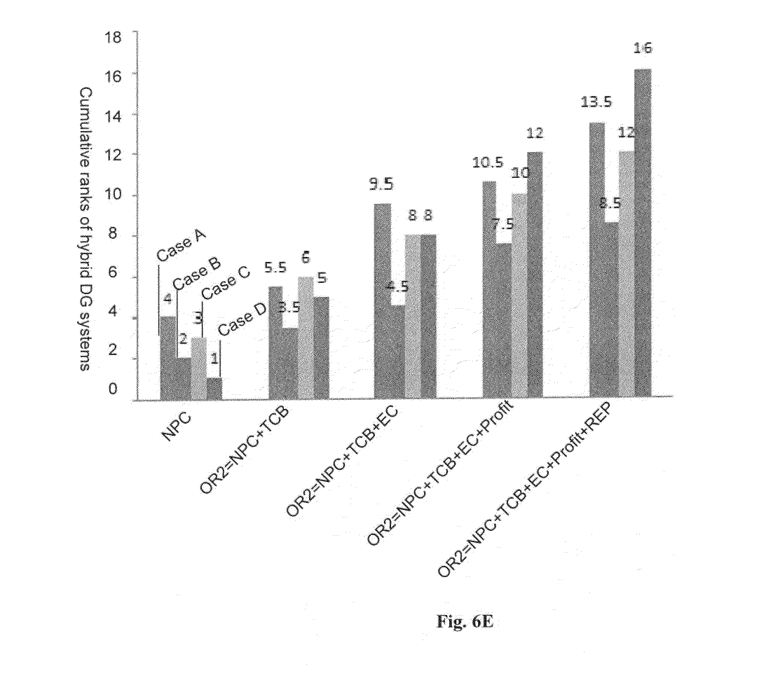

FIGS. 6A-6D illustrate four hybrid systems considered in micro-grid planning according to another embodiment. The first system 601 (referred to herein as case A) depicted in FIG. 6A is a hybrid grid-connected wind/hydro/diesel without storage energy system. The system 601 includes a wind power source 602, a hydro power source 603, a diesel generator 604, a grid unit 605, an AC power supply line 606, and a primary load 607.

FIG. 6B is a hybrid grid-connected wind/hydro/PV with storage power system 612 (referred to herein as case B). The system 612 includes a wind power source 613, a hydro power source 614, a grid unit 615, an AC power supply line 616a, a DC power supply line 616b, a PV power source 617, a battery 618, a converter 619 configured to convert AC-DC power supply and vice-versa, and a primary load 620.

FIG. 6C depicts a hybrid grid-connected hydro/PV with storage energy system 623 (referred to herein as case C). The system 623 includes a hydro power source 624, a grid unit 625, AC and DC power supply lines 626a and 626b respectively, a PV power source 627, a battery 628, a converter 629 configured to convert AC-DC power supply and vice-versa, and a primary load 630. FIG. 6D depicts a grid only energy system 633 (referred to herein as case D) that includes a grid unit 634, an AC power supply line 635, and a primary load 636. Note that the energy systems considered in the present embodiment, are connected to the external grid and serve a primary load with average energy supply of 50 MWh/h/day and a peak demand of 58798 kW.

Table X depicts a ranking for the parameters NPC, TCB, EC, net profit, and REP for the hybrid systems of FIGS. 6A-6D. In the analysis of the present embodiment, the OSIP parameter TE was replaced with the OSIP parameter emission cost (EC). The cost of one ton of emissions was assumed to be $110/ton. Further, two new OSIPs; TCB and net profit to the DG operator (Profit to DGO) are considered. The parameter profit to DGO is computed as a percentage of grid sales of energy and 6% of grid sales were assumed to be profit to DGO. Note from FIG. 8 (at the end of the document) that a purely renewable case B was chosen as the best or efficient system. Table XI depicts a computation of the profit to the DGO for the four hybrid systems of FIGS. 6A-6D. Note that considering only the net profit to DGO parameter, the system of case A is the most efficient. Furthermore, Tables XII and XIII depict the comparison of the TCB parameter and the EC for the four hybrid systems of FIGS. 6A-6D.

TABLE X
rankings for the hybrid systems of FIGS. 6A-6D.

| | | | | | Emission cost | | Net profit by the | | REP | | |
|---|---|---|---|---|---|---|---|---|---|---|---|
| | NPC Ranking | | TCB Ranking | | Ranking | | DGO ranking | | ranking | | |
| Hybrid DG | NPC | | TCB | | EC Cost | | Profit | | REP | | Overall |
| system | ($/yr.) | Rank | (%) | Rank | ($/yr.) | Rank | ($/yr.) | Rank | (%) | Rank | Rank |
| Case A | 428,195,168 | 4 | 0 | 1.5 | 1335163.4 | 4 | 592062.1 | 1 | 67.5 | 3 | 13.5 |
| Case B | 122,882,720 | 2 | 0 | 1.5 | −7154186270 | 1 | 224946.1 | 3 | 100 | 1 | 8.5 |
| Case C | 208,793,248 | 3 | 18.11 | 3 | −2166887690 | 2 | 275913.8 | 2 | 93.7 | 2 | 12 |
| Case D | 43,572,832 | 1 | 100 | 4 | 1276965.5 | 3 | 0 | 4 | 0 | 4 | 16 |

TABLE XI
Comparison of profit to DGO.

| | | Profit of |
|---|---|---|
| Hybrid DG | Grid sales | DGO |
| system | (kWh/y) | ($/yr.) |
| Case A | 39,209,412 | 592062.1 |
| Case B | 102,248,232 | 224946.1 |
| Case C | 34,275,004 | 275913.8 |
| Case D | 0 | 0 |

TABLE XII
Comparison of Transmission Capacity Burden.

| Hybrid | Supply to the | Grid | |
|---|---|---|---|
| DG | load (ED) | purchase(Egrid) | TCB |
| system | kWh/year | kWh/year | (%) |
| Case A | 18,250,482 | 0 | 0 |
| Case B | 18,250,482 | 0 | 0 |
| Case C | 18,250,482 | 3,305,662 | 18.11 |

TABLE XIII
Comparison of Emissions Cost.

| Emission | Case A | Case B | Case C | Case D |
|---|---|---|---|---|
| Carbon dioxide | 11,695,985 | −64,620,884 | −19,572,624 | 11,534,315 |
| Carbon monoxide | 410,454 | 0 | 0 | 0 |
| Sulfur dioxide | 25,160 | −280,160 | −84,856 | 50,006 |
| Nitrogen oxides | 6,250 | −137,013 | −41,499 | 24,456 |
| Total emission kg) | 12,137,849 | −65038057 | −19,698,979 | 11,608,777 |
| EC, (TE * $110/ton) | 1335163.4 | −7154186270 | −2166887690 | 1276965.5 |

FIG. 6E depicts a cumulative ranking of the parameters shown in Table X. The Y-axis depicts the cumulative ranks of the hybrid systems and the X-axis depicts the number of parameters considered while computing the cumulative ranks. For instance, the first scenario (depicted on the left hand side of the graph) considers only the NPC parameter for computing the cumulative ranks of the hybrid systems. The next scenario considers the NPC and TCB parameters for evaluating the cumulative ranks. Similarly, the last scenario considers the NPC, TCB, EC, profit and REP parameters for computing the cumulative ranks. Further, each scenario depicted in FIG. 6E includes four vertical bars that correspond to Case A-Case D, wherein the height of a particular bar represents the magnitude of the cumulative rank. Further, while considering all the OSIP parameters for evaluating the overall rank of each hybrid system, it is observed that Case B is the most efficient energy system with an overall rank of 8.5.

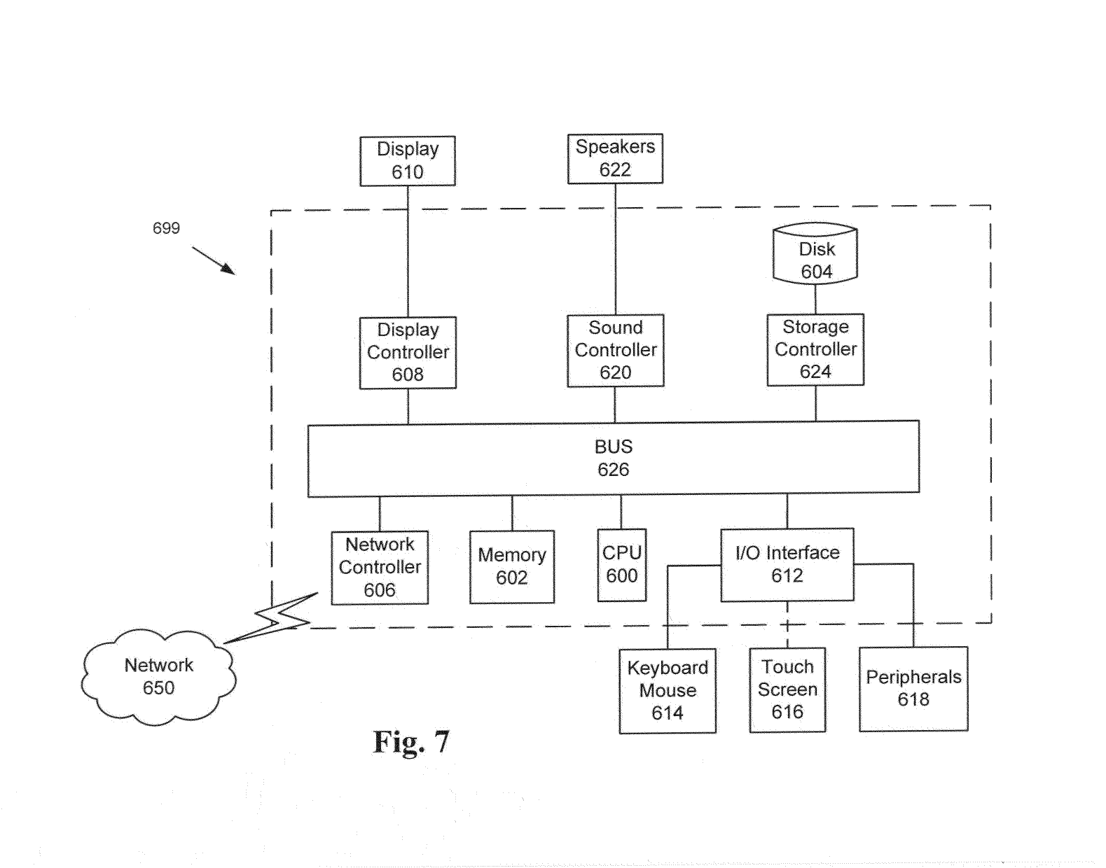

FIG. 7 illustrates a block diagram of a computing device according to an embodiment. In FIG. 7, the computer 799 includes a CPU 700 which performs the processes described above. The process data and instructions may be stored in memory 702. These processes and instructions may also be stored on a storage medium disk 704 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the system communicates, such as a server or computer.

Further, the claimed advancements may be provided as a utility application, background daemon, or component of an operating system, or combination thereof, executing in conjunction with CPU 700 and an operating system such as Microsoft Windows 7, UNIX, Solaris, LINUX, Apple MAC-OS and other systems known to those skilled in the art.

CPU 700 may be a Xenon or Core processor from Intel of America or an Opteron processor from AMD of America, or may be other processor types that would be recognized by one of ordinary skill in the art. Alternatively, the CPU 700 may be implemented on an FPGA, ASIC, PLD or using discrete logic circuits, as one of ordinary skill in the art would recognize. Further, CPU 700 may be implemented as multiple processors cooperatively working in parallel to perform the instructions of the inventive processes described above.

The computer 799 in FIG. 7 also includes a network controller 706, such as an Intel Ethernet PRO network interface card from Intel Corporation of America, for interfacing with network 750. As can be appreciated, the network 750 can be a public network, such as the Internet, or a private network such as an LAN or WAN network, or any combination thereof and can also include PSTN or ISDN sub-networks. The network 750 can also be wired, such as an Ethernet network, or can be wireless such as a cellular network including EDGE, 3G and 4G wireless cellular systems. The wireless network can also be Wi-Fi, Bluetooth, or any other wireless form of communication that is known.

The computer 799 further includes a display controller 708, such as a NVIDIA GeForce GTX or Quadro graphics adaptor from NVIDIA Corporation of America for interfacing with display 710, such as a Hewlett Packard HPL2445w LCD monitor. A general purpose I/O interface 712 interfaces with a keyboard and/or mouse 714 as well as a touch screen panel 716 on or separate from display 710. General purpose I/O interface also connects to a variety of peripherals 718 including printers and scanners, such as an OfficeJet or DeskJet from Hewlett Packard.

A sound controller 720 may also be provided in the computer 799, such as Sound Blaster X-Fi Titanium from Creative, to interface with speakers/microphone 722 thereby providing sounds and/or music. The speakers/microphone 722 can also be used to accept dictated words as commands.

The general purpose storage controller 724 connects the storage medium disk 704 with communication bus 726, which may be an ISA, EISA, VESA, PCI, or similar, for interconnecting all of the components of the robot-guided medical procedure system. A description of the general features and functionality of the display 710, keyboard and/or mouse 714, as well as the display controller 708, storage controller 724, network controller 706, sound controller 720, and general purpose I/O interface 712 is omitted herein for brevity as these features are known.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

1. A method of determining an efficient energy system from a plurality of energy systems, the method comprising:
assigning to each distributed energy system, a rank for each parameter of a plurality of parameters based on a simulated value of the parameter, the plurality of parameters governing a performance of each energy system;
computing an overall rank for each energy system based on the assigned rank to each parameter of the plurality of parameters;
calculating, for each energy system, a cumulative rank for a subset of the plurality of parameters based on the assigned rank of each parameter belonging to the subset of the plurality of parameters;
identifying whether a single energy system has a minimum overall rank or multiple energy systems have the minimum overall rank; and
determining, based on the identifying, one of the efficient energy system to correspond to the single energy system, and the efficient energy system being computed based on the cumulative ranks of the multiple energy systems.

2. The method of claim 1, wherein the plurality of parameters include net present cost, levelized cost of energy, total emissions or emission cost, renewable energy penetration transmission capacity burden, and the profit to distributed energy system operator.

3. The method of claim 1, wherein the overall rank of the energy system is computed as a sum of the assigned ranks of the plurality of parameters.

4. The method of claim 1, wherein the simulated value of the parameter corresponding to the energy system is obtained by simulating the energy system on a software tool.

5. The method of claim 1, further comprising:
applying additional constraints to the multiple energy systems in order to determine the efficient energy system.

6. The method of claim 5, wherein the additional constraint is determining amount of solar radiation and wind speed available in a geographical location of the energy system.

7. The method of claim 2, wherein the parameter net present cost corresponding to the energy system having the lowest net present cost of the plurality of energy systems is assigned a rank 1.

8. The method of claim 2, wherein the parameter levelized cost of energy corresponding to the energy system having the lowest levelized cost of energy of the plurality of energy systems is assigned a rank 1.

9. The method of claim 2, wherein the parameter renewable energy penetration corresponding to the energy system having the highest renewable energy penetration of the plurality of energy systems is assigned a rank 1.

10. The method of claim 2, wherein the parameter levelized cost of energy (LCOE) is computed as:
$$LCOE = \frac{{C}_{TANN}}{{E}_{ls} + {E}_{grid}} ,$$
wherein, C_{TANN} is the total annualized cost, Eₗₛ is electrical energy served by the energy system, and E_{grid} is the amount of electricity sold to a grid by the energy system.

11. The method of claim 1, wherein the parameter transmission capacity burden is computed as:
$$TCB = \frac{{E}_{grid}}{{E}_{D}} * 100 \% ,$$
wherein, E_{D} is the total energy supplied to a load and E_{grid} is the energy supplied to the load from a grid.

12. The method of claim 2, wherein the parameter profit to distributed energy system operator is computed as a percentage of grid sales of energy by the distributed energy system operator.

13. The method of claim 2, wherein the parameter profit to distributed energy system operator corresponding to the energy system with the highest profit to the parameter profit to distributed energy system operator is assigned rank 1.

14. A non-transitory computer readable medium having stored thereon a program that when executed by a computer causes the computer to execute a method of determining an efficient energy system from a plurality of energy systems, the method comprising:
assigning to each distributed energy system, a rank for each parameter of a plurality of parameters based on a simulated value of the parameter, the plurality of parameters governing a performance of each energy system;
computing an overall rank for each energy system based on the assigned rank to each parameter of the plurality of parameters;
calculating, for each energy system, a cumulative rank for a subset of the plurality of parameters based on the assigned rank of each parameter belonging to the subset of the plurality of parameters;
identifying whether a single energy system has a minimum overall rank or multiple energy systems have the minimum overall rank; and
determining, based on the identifying, one of the efficient energy system to correspond to the single energy system, and the efficient energy system being computed based on the cumulative ranks of the multiple energy systems.

15. The non-transitory computer readable medium of claim 14, wherein the plurality of parameters include net present cost, levelized cost of energy, total emissions, renewable energy penetration, transmission capacity burden, and profit to distributed energy system operator.

16. The non-transitory computer readable medium of claim 14, wherein the overall rank of the energy system is computed as a sum of the assigned ranks of the plurality of parameters.

17. The non-transitory computer readable medium of claim 14, wherein the simulated value of the parameter corresponding to the energy system is obtained by simulating the energy system on a software tool.

18. The non-transitory computer readable medium of claim 15, wherein the parameter net present cost corresponding to the energy system having the lowest net present cost of the plurality of energy systems is assigned a rank 1.

19. The non-transitory computer readable medium of claim 15, wherein the parameter renewable energy penetration corresponding to the energy system having the highest renewable energy penetration of the plurality of energy systems is assigned a rank 1.

20. The non-transitory computer readable medium of claim 14, further comprising:
applying additional constraints to the multiple energy systems in order to determine the efficient distributed energy system.

21. The non-transitory computer readable medium of claim 20, wherein the additional constraint is determining amount of solar radiation and wind speed available in a geographical location of the energy system.

22. The non-transitory computer readable medium of claim 15, wherein the parameter levelized cost of energy (LCOE) is computed as:
$$LCOE = \frac{{C}_{TANN}}{{E}_{ls} + {E}_{grid}} ,$$
wherein, C_{TANN} is the total annualized cost, Eₗₛ is electrical energy served by the energy system, and E_{grid} is the amount of electricity sold to a grid by the energy system.
